(19) United States
(12) Patent Application Publication
(10) Pub. No.: US 2026/0166686 A1
(43) Pub. Date: Jun. 18, 2026

(54) FAUCET REMOVAL SOCKET SYSTEM AND METHOD

(71) Applicant: DARREN CHALKLY, MISSION VIEJO, CA (US)

(72) Inventor: DARREN CHALKLY, MISSION VIEJO, CA (US)

(21) Appl. No.: 18/983,557

(22) Filed: Dec. 17, 2024

(51) Int. Cl. B25B 13/48

(52) U.S. Cl. CPC B25B 13/481

(57) ABSTRACT

A tool comprises a first capture component having a first configuration to hold a first non-tool component. A first drive aperture in the first capture component is completely offset from a longitudinal centerline of the tool. A second capture component has a second configuration to hold a second non-tool component. The first and second capture components are further configured to receive a third non-tool component attached to one of the first non-tool component and the second non-tool component. The first and second capture components are further configured to be rotated by a non-tool drive mechanism that engages the first and second capture components at positions thereon that are completely offset from a longitudinal centerline of the tool.

### BACKGROUND OF THE DISCLOSURE

The present invention relates to a tool for tightening and loosening a domestic faucet fitting.

Faucets are typically affixed atop a platform and secured in place by a nut under the platform. A difficulty encountered when removing and/or replacing the faucet is removing and/or replacing the nut that secures the faucet. The nut can be difficult to access. Different faucets may use different nuts which, in turn, may require different equipment to remove/replace the nut. Nuts will also differ in size and shape depending on the age of the unit and the manufacturer.

Many new faucets have captive screws that fit through the threaded holes in a ‘yolk’ type backnut and it is the thread of the screws that push up against the underside of the platform to provide the clamping force as opposed to nut face itself. In some instances, two screws are used 180 degrees apart. In other instances, three screws are used 120 degrees apart. Of course, in an ideal world when removing this type of securing mechanism, the screws would be rotated down to release the clamping force but over time, in damp conditions, these screws become rusted and will not spin to loosen. This will ordinarily result in the screw heads being chewed and the plumber having to resort to mechanically cutting out or drilling out the screws and in many cases, removing the whole sink or basin assembly.

An existing tool comprises a spring-loaded arcuate finger which is knurled on an inside thereof, the spring-loading urging the finger towards a further part of the tool, so that the finger and further part together can engage a nut such that rotation of the tool about an axis thereof can be used to tighten or loosen the nut. A disadvantage of such a tool is that it may fail to grip the nut which it is intended to rotate, or if it does grip the nut, it may deform it without rotating it, especially if the nut is made of a plastics material.

As can be seen, there is a need for improved systems and methods for removing and/or replacing nuts in general and in specific applications.

### SUMMARY OF THE DISCLOSURE

In one aspect of the present disclosure, a tool comprises a first capture component having a first configuration to hold a first non-tool component; a first drive aperture in the first capture component and completely offset from a longitudinal centerline of the tool; a second capture component having a second configuration to hold a second non-tool component; wherein the first and second capture components are further configured to receive a third non-tool component attached to one of the first non-tool component and the second non-tool component; and wherein the first and second capture components are further configured to be rotated by a non-tool drive mechanism that engages the first and second capture components at positions thereon that are completely offset from a longitudinal centerline of the tool.

In another aspect of the present disclosure, a tool comprises a first socket having a first configuration to rotate a first non-tool nut; a first drive aperture in the first socket and completely offset from a longitudinal centerline of the tool; a second socket having a second configuration to rotate a second non-tool nut; wherein the second configuration is different from the first configuration in at least one of size and shape; a second drive aperture in the second socket and completely offset from the longitudinal centerline of the tool; and an insertion gap that extends through the first and second sockets and is configured to receive a non-tool component that is affixed to one of the first non-tool nut and the second non-tool nut.

In a further aspect of the present disclosure, a tool comprises a first socket having a first configuration to receive and rotate a first non-tool nut about a longitudinal centerline of the tool; wherein the first configuration enables the first socket to receive the first non-tool nut in a first direction parallel to the longitudinal centerline; a second socket having a second configuration to receive and rotate a second non-tool nut about the longitudinal centerline of the tool; wherein the second configuration enables the second socket to receive the second non-tool nut in a second direction that is opposite the first direction; wherein the second configuration is different from the first configuration; a midline shelf between the first and second sockets that supports the first non-tool nut in the first socket and supports the second non-tool nut in the second socket; and an insertion gap that is configured to receive a non-tool component that is affixed to one of the first non-tool nut when received by the first socket and the second non-tool nut when received by the second socket.

These and other features, aspects and advantages of the present disclosure will become better understood with reference to the following drawings, description, and claims.

### BRIEF DESCRIPTION OF THE DRAWINGS

FIG. 1 is a top perspective view of a tool according to an embodiment of the present disclosure.

FIG. 2 is a bottom perspective view of a tool according to an embodiment of the present disclosure.

FIG. 3 is a top perspective view of a first capture component of a tool according to an embodiment of the present disclosure.

FIG. 4 is a side perspective view of a first capture component of a tool according to an embodiment of the present disclosure.

FIG. 5 is a rear elevation view of a tool according to an embodiment of the present disclosure.

FIG. 6 is a top perspective view of a second capture component of a tool according to an embodiment of the present disclosure.

FIG. 7 is a side perspective view of a second capture component of a tool according to an embodiment of the present disclosure.

FIGS. 8A-8B are top perspective views showing exemplary nuts for use by a tool according to embodiments of the present disclosure.

### DESCRIPTION OF THE DISCLOSURE

The following detailed description is of the best currently contemplated modes of carrying out the disclosure. The description is not to be taken in a limiting sense, but it is made merely for the purpose of illustrating the general principles of the disclosure, since the scope of the disclosure is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

Herein, the term “directly” in the context of two components is intended to mean that there is not a third component therebetween.

Herein, references to matters in the singular or plural are intended to include the other as well.

The technical problems to be solved are removing a non-tool component (such as a nut) which may be located under a platform and which secures another non-tool component (such as a faucet) which may be located on top of the platform. The nut may be in different sizes and shapes depending on the application. However, a single tool should be able to tighten or loosen nuts - while accounting for different shapes of nuts.

Broadly, the present disclosure solves the foregoing problems by a single, integrated or monolithic tool having a first capture component (such as a first socket) and an oppositely facing second capture component (such as a second socket). A first hex and a second hex can respectively be in the first and second sockets. The first and second hexes can be of different configurations, such as a square, to directly accommodate different configured “standard” nuts without an adaptor or the like. To accommodate different sized nuts, multiple tools of different socket sizes may be employed.

Further, the present disclosure solves the foregoing problems by the first and second capture components having recesses to receive ear portions and/or screws/bolts along a perimeter of a nut. The first and second capture components can be configured to directly accommodate different number of ear portions and/or screws/bolts without an adaptor or the like.

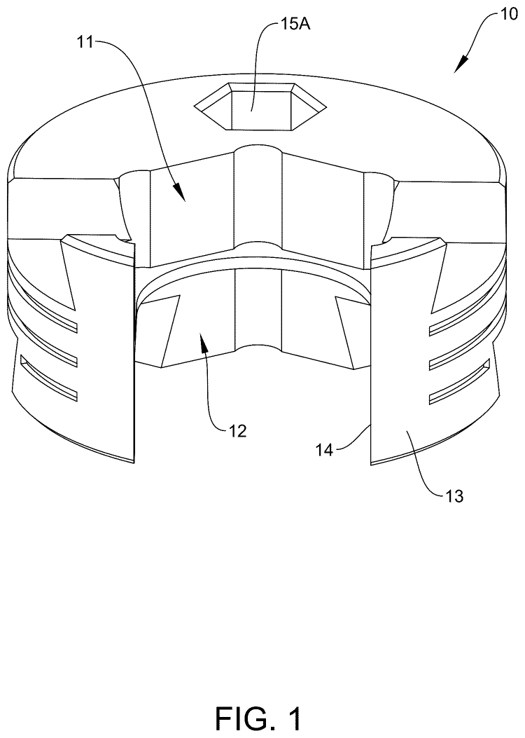

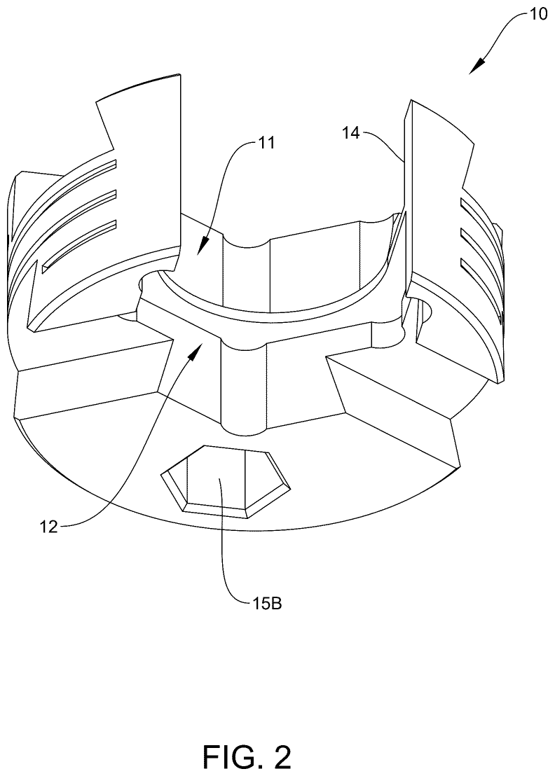

FIGS. 1-2 are front perspective views of a tool 10 according to an exemplary embodiment of the present disclosure. In an embodiment, the tool 10 is a single, integrated or monolithic structure. In an embodiment, the tool 10 may include a first capture component 11, such as a first socket, that interfaces a second capture component 12, such as a second socket. In an embodiment, the first capture component 11 can be back-to-back with the second capture component 12. In an embodiment, the first capture component 11 may be oppositely facing with the second capture component 12. In an embodiment, the first capture component 11 and the second capture component 12 are wholly integrated with one another. In other words, the first capture component 11 and the second capture component 12 consist of a single monolithic structure, according to an embodiment.

In an embodiment, the first capture component 11 may be sized and configured to directly receive, hold, and rotate a first non-tool component, such as a first non-tool nut, as further described below. In an embodiment, the second capture component 12 may be sized and configured to directly receive, hold, and rotate a second non-tool component, such as a second non-tool nut, as further described below. In an embodiment, the configuration of the first and second capture components may be the same or may be different.

According to an embodiment, the tool 10 may further include an outer or exterior wall 13. In an embodiment, the exterior wall 13 may be formed by exterior surfaces of the first and second capture components 11, 12. The exterior wall 13 may be generally cylindrical in shape, in an embodiment.

An insertion gap 14 may also be formed by and extend through the first and second capture components 11, 12, in an embodiment. Thereby, the insertion gap 14 may interrupt the exterior wall 13 to form a partial cylindrical shape of the exterior wall 13. The insertion gap 14 may be sized and configured to directly receive another non-tool component, such as a hose that is attached to a nut, as further described below.

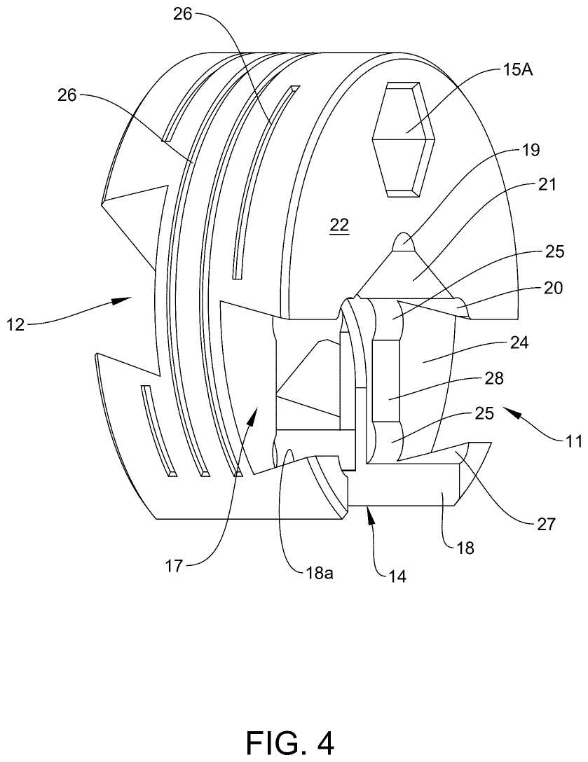

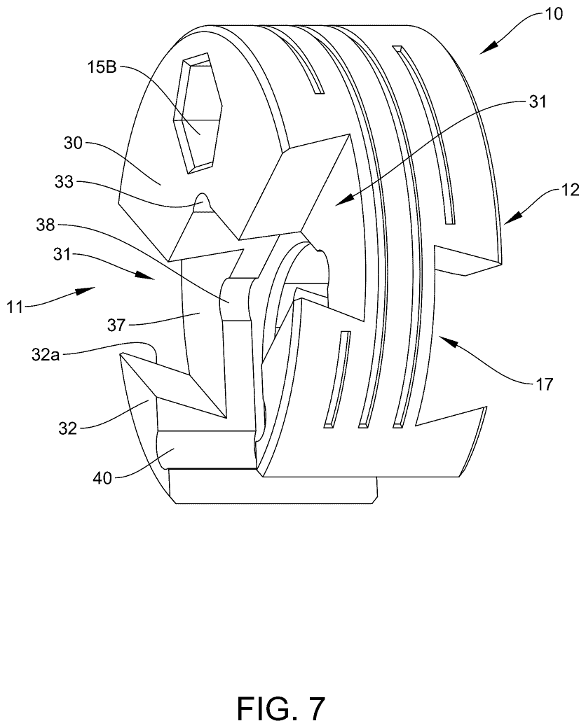

In an embodiment, the tool 10 may include a first drive aperture 15A associated with the first capture component 11 (FIG. 1). The tool 10 may further include a second drive aperture 15B associated with the second capture component 12 (FIG. 2), in an embodiment. The first and second drive apertures 15A-B may be sized and configured to receive a non-tool drive mechanism(s), such as a ratchet, to respectively rotate the first and second non-tool components, as further described below. In an embodiment, the first and second drive apertures 15A, 15B can be completely offset from a longitudinal centerline C further described below (FIGS. 4 and 7).

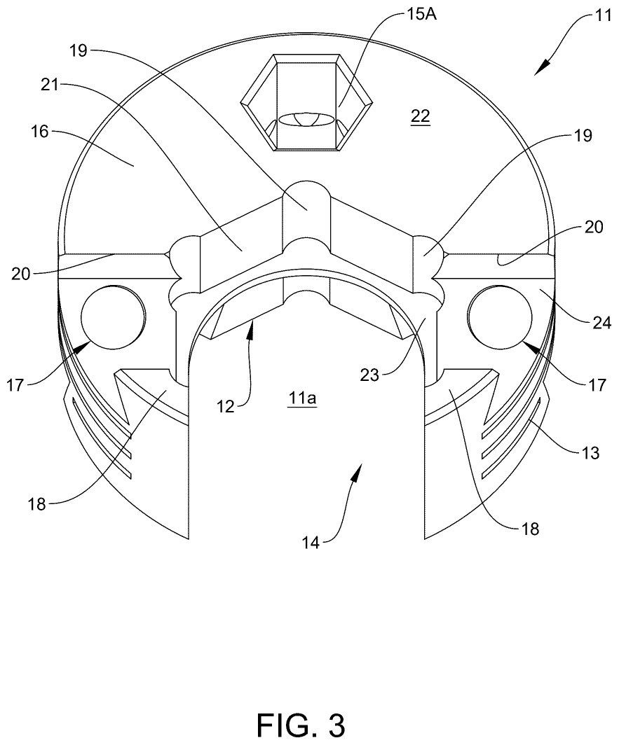

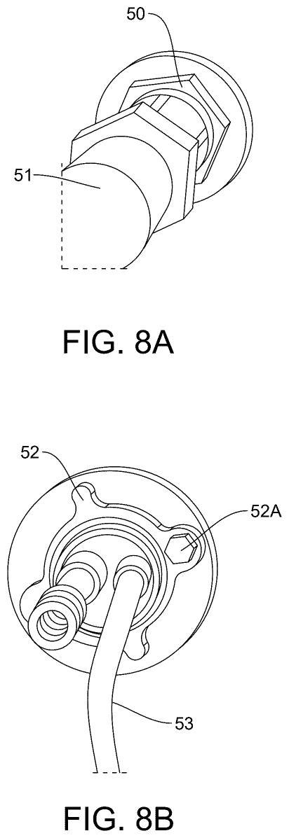

FIG. 3 is a top, perspective view of a first socket 11 according to an exemplary embodiment of the present disclosure. The first socket 11 may include a first receiving area 11a which can be sized and configured to directly receive, hold and rotate the first non-tool nut (FIGS. 8A-8B). The first receiving area 11a may be configured to receive the first non-tool nut in a direction parallel to a longitudinal centerline C of the tool 10 (FIG. 4). In an embodiment, the receiving area 11a may have a partial hexagon shape.

In an embodiment, the first socket 11 may include a first base 16 that is outside of the first receiving area 11a and is configured to form a part of the shape or perimeter of the first receiving area 11a. In an embodiment, the first base 16 may have an arc shape. In an embodiment, the first base 16 may have a semi-circular shape.

In FIG. 3, according to an embodiment, the first base 16 may have a first base plateau or top surface 22. The first base 16 may further have a first base interior wall 21 that directly interfaces the first receiving area 11a, in an embodiment. The first base interior wall 21 may be shaped to provide or define a part of the shape of a perimeter of the first receiving are 11a.

The first base interior wall 21 may include one or more first base channels 19, in an embodiment. The one or more first base channels 19 can extend in a longitudinal direction from the first base plateau 22 and towards the second socket 12, in an embodiment. The one or more first base channels 19 can be configured and dimensioned to receive one or more parts of the first non-tool nut, such as corners 50 or ear portions 52 thereof, according to an embodiment (FIGS. 8A-8B). According to an embodiment, three first base channels 19 are in the first base interior wall 21.

In an embodiment, the first base 16 may further have a first base end wall 20 at one or both distal ends of the first base 16. In an embodiment, the first base end wall 20 can extend from the first base interior wall 21 and to the exterior wall 13. In an embodiment, the first base end wall(s) 20 can provide or define a part of one or more first perimeter recesses 17 described below. The first base end wall(s) 20 may be perpendicular to a first perimeter recess base 24 described below, in an embodiment. In another embodiment, the first base end wall(s) 20 may be non-perpendicular to the first perimeter recess base 24. In an embodiment, the first base end wall(s) 20 may be inclined whereby the part of the wall 20 at the first base plateau 22 extends further into the first perimeter recess 17 in comparison to the part of the wall 20 that meets the first perimeter recess base 24. In other words, the first base end wall(s) may be inclined from a top thereof and inwardly towards a bottom thereof.

In FIGS. 3 and 4, the first perimeter recess 17 can be at one or both distal ends of the first base 16, in an embodiment. The first perimeter recesses 17 may be 180 degrees apart, in an embodiment. The first perimeter recess(es) 17 can be configured and dimensioned to directly receive and hold an ear portion 52 and/or screw 52A of a first non-tool nut (FIG. 8B), according to an embodiment. In an embodiment, one or both first perimeter recesses 17 can be arc shaped. In an embodiment, one or both first perimeter recesses 17 can be reverse tapered in shape - i.e., opposing walls of the recess 17 taper inwardly from top to bottom.

In an embodiment, a first end post 18 can be at a side of the first perimeter recess(es) 17 which is opposite the first base end wall 20. In an embodiment, one or two first end posts 18 can be at either side of the insertion gap 14. The first end post 18 can include a first end post wall 18a that faces the first base end wall 20, in an embodiment.

According to an embodiment, the first end post wall 18a may be perpendicular to the first perimeter recess base 24 described below. In another embodiment, the first end post wall 18a may be non-perpendicular to the first perimeter recess base 24. In an embodiment, the first end post wall 18a may be inclined whereby the wall 18a at a point across from the first base plateau 22 extends further into the first perimeter recess 17 in comparison to where the wall 18a meets the first perimeter recess base 24. The first end post wall 18a can provide or define a part of the first perimeter recess 17, in an embodiment. The first end post wall 18a and the first base end wall 20 can thereby define walls of the first perimeter recess 17.

In an embodiment, if the first end post wall 18a and the first base end wall 20 are inclined away from one another, the first perimeter recess 17 can have a reverse tapered shape. With a reverse tapered shape, and in the context where the first non-tool nut includes screws (FIG. 8B), the first perimeter recess 17 can receive a head of a screw. When the first socket 11 is rotated, as described below, the walls of the first perimeter recess 17 can tend to pull the first socket 11 onto the screwhead, in an embodiment. In turn, the possibility of the first socket 11 slipping off the screwhead is lowered, in an embodiment.

In FIG. 4, according to an embodiment, one or both of the first end posts 18 may include a first end post channel 27. In an embodiment, the first end post channel 27 may extend from a distal or top end of the first end post 18 and to the first perimeter base 24 described below. The first end post channel 27 can be configured and dimensioned to receive one or more parts of the first non-tool nut, such as corners thereof, according to an embodiment (FIG. 8A).

The first perimeter recess 17 can further include the first perimeter recess base 24 which can serve as a bottom of the recess 17, in an embodiment. The first perimeter base 24 can be configured, in an embodiment, to support an ear portion and/or screw of the first non-tool nut (FIG. 8B).

In FIG. 4, the first perimeter recess base 24 may include a first perimeter recess base interior wall 28, in an embodiment. The first perimeter recess base interior wall 28 may directly interface the first receiving area 11a, in an embodiment. The first perimeter recess base interior wall 28 may be shaped to provide or define a part of the shape or perimeter of the first receiving area 11a.

One or more first perimeter recess base channels 25 can be in the first perimeter recess base interior wall 28, in an embodiment. The one or more first perimeter recess base channels 25 can be configured and dimensioned to receive one or more parts of the first non-tool nut, such as corners thereof, according to an embodiment (FIG. 8A).

In FIGS. 3 and 4, according to an embodiment, a midline shelf 23 can be intermediate the first and second sockets 11, 12. In an embodiment, the midline shelf 23, in an embodiment, can separate the first receiving area 11a from a second receiving area 12a of the second socket 12 as described below. According to an embodiment, the midline shelf 23 can extend along respective perimeters of the first and second receiving areas 11a, 12a. Further, the midline shelf 23 can extend beyond the first base interior wall 21 and beyond the first perimeter recess base interior wall 28. Thereby, in an embodiment, the midline shelf 23 can support a first non-tool nut in the receiving area 11a and prevent the same from entering the second receiving area 12a.

In FIG. 4, the first drive aperture 15A is located completely offset from a longitudinal centerline C, according to an embodiment. Such offset can enable a non-tool drive mechanism, such as a ratchet, to be inserted into the first drive aperture even while a non-tool component, such as a non-tool nut attached to a hose 51, 53 (FIGS. 8A-8B), is within the first insertion area 11a, in an embodiment.

In FIG. 4, in an embodiment, the exterior wall 13 may include one or more exterior wall channels 26. The one or more exterior wall channels 26 may extend circumferentially therein, in an embodiment. The one or more exterior wall channels 26 may serve to provide a friction surface to a user's hand or additional tool when rotating the tool 10.

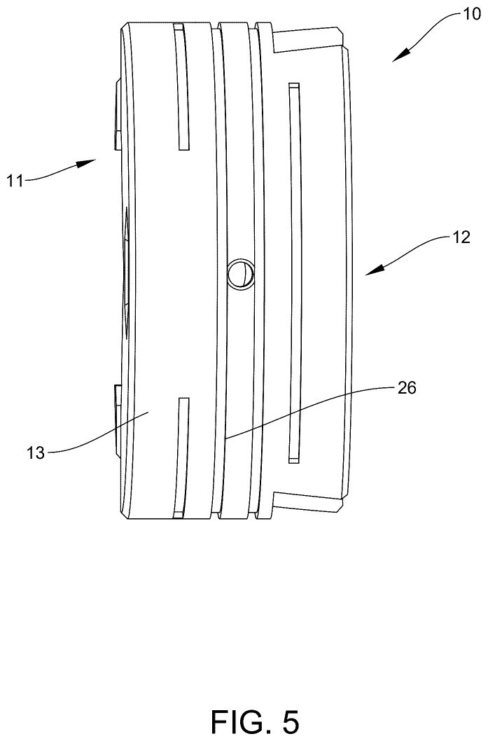

In FIG. 5, the one or more exterior wall channels may extend to a rear side of the tool 10.

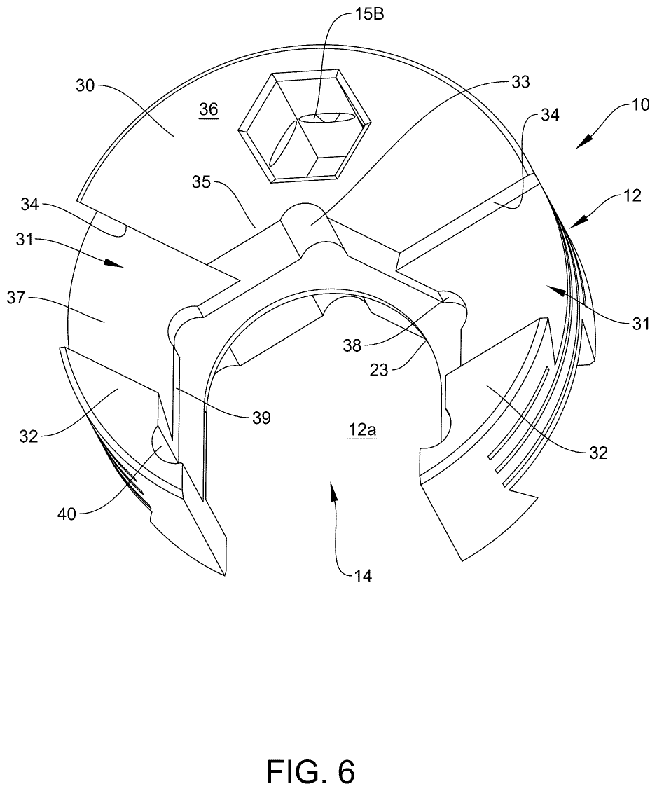

FIG. 6 is a top, perspective view of a second socket 12 according to an exemplary embodiment of the present disclosure. The second socket 12 may be configured and sized the same as the first socket 11 or configured differently from and sized the same as the first socket 11. If configured differently, as an example, the first socket 11 may be used to rotate a first non-tool nut having a standard hex shape (e.g., FIG. 8A), while the second socket 12 may be used to rotate a second non-tool nut having ear portions and screws (e.g., FIG. 8B).

In embodiments, the construction elements or components, and the functions they can provide, of the second socket 12 can be the same as those in the first socket 11. However, the configuration of those construction elements may differ between the two sockets 11, 12. For purposes of brevity and clarity, the following description of the second socket 12 will not repeat the entire description of the same elements in the first socket 11.

In an embodiment, the second socket 11 may include a second receiving area 12a which can have the same or different configuration from the first receiving area 11a. The second receiving area 12a may be configured to receive the second non-tool nut in a direction parallel to the longitudinal centerline C of the tool 10, but opposite to the direction that the first receiving area 11a receives the first non-tool nut (FIG. 7). In an embodiment, the second socket 11 may include a second base 30 like that of the first base 16. In an embodiment, the second base 30 may have an arc shape. In an embodiment, the second base 30 may extend over an arc of less degrees than the first base 16, such as 120 degrees.

In FIG. 6, according to an embodiment, the second base 30 may have a second base plateau or top surface 36 and a second base interior wall 35 that directly interfaces the second receiving area 12a, like the first base plateau 22 and the first base interior wall 21, in an embodiment.

The second base interior wall 35 may include one or more second base channels 33, like the first base interior wall 21 and the first base channels 19, in an embodiment. The one or more second base channels 33 can be configured and dimensioned to receive one or more parts of the second non-tool nut, such as corners thereof, according to an embodiment (FIG. 8A). According to an embodiment, one second base channel 33 is in the second base interior wall 35.

In an embodiment, the second base 16 may further have a second base end wall 34 at one or both distal ends of the second base 30, like the first base end wall 20. The second base end wall(s) 34 may be perpendicular to a second perimeter recess base 37 described below, in an embodiment. In another embodiment, like the first base end wall(s) 20, the second base end wall(s) 34 may be non-perpendicular to a second perimeter recess base 37 described below. In an embodiment, like the first base end wall(s) 20, the second base end wall(s) 34 may be inclined from a top thereof and inwardly toward a bottom thereof.

In FIGS. 6 and 7, a second perimeter recess 31 can be at one or both distal ends of the second base 30, like the first perimeter recess 17, in an embodiment. The second perimeter recess(es) 31 can be configured and dimensioned to directly receive and hold an ear portion and/or screw of a second non-tool nut (FIG. 8B), according to an embodiment. In an embodiment, one or both second perimeter recesses 31 can be arc shaped. In an embodiment, one or both second perimeter recesses 31 can be reverse tapered in shape - i.e., opposing walls of the recess 31 taper inwardly from top to bottom.

In an embodiment, like the first end post 18, a second end post 32 can be at a side of the second perimeter recess(es) 31 which is opposite the second base end wall 34. In an embodiment, one or two first end posts 18 can be at either side of the insertion gap 14. The second end post 32 can include a second end post wall 32a that faces the second base end wall 34, in an embodiment.

According to an embodiment, like the first end post wall 18a, the second end post wall 32a may be perpendicular or non-perpendicular to a second perimeter recess base 37. In another embodiment, the second end post wall 32a may be inwardly inclined toward a bottom thereof and may provide or define a part of the second perimeter recess 31, in an embodiment. The second end post wall 32a with the second base end wall 34 can thereby define walls of the second perimeter recess 31.

In an embodiment, if the walls of the second perimeter recess 31 are both inwardly inclined, the second perimeter recess 31 can have a reverse tapered shape, like the first perimeter recess 17.

In FIG. 7, according to an embodiment, one or both second end posts 32 may include a second end post channel 40, like the first end post channel 27.

The second perimeter recess 31 can further include the second perimeter recess base 37 which can serve as a bottom of the recess 31, like the first perimeter recess base 24, in an embodiment.

In FIG. 7, the second perimeter recess base 37 may include a second perimeter recess base interior wall 39, like the first perimeter recess base interior wall 28, in an embodiment. One or more second perimeter recess base channels 38 can be in the second perimeter recess base interior wall 39, like the first perimeter recess base channels 25, in an embodiment.

In use, the tool 10 can be placed longitudinally parallel with a nut/hose whereby the insertion gap 14 faces the hose 51, 53. The tool 10 can then be moved to place the hose within the insertion gap 14. Next, the tool 10 can be moved onto the nut. The tool 10 can be rotated in either direction until corners of the nut are positioned at the channels 19, 25, 27/33, 38, 40. Concurrently, ear portions of the nut can be positioned at the channels 19, 33 and/or perimeter recesses 17, 31. So positioned, the tool 10 can then be further moved longitudinally until the nut rests on the midline shelf 23. A ratchet may then be inserted into the drive aperture 15A, 15B and then rotated to cause rotation of the tool 10 and thus the nut.

It should be understood, of course, that the foregoing relates to exemplary embodiments of the disclosure and that modifications may be made without departing from the scope of the disclosure as set forth in the following claims.

We claim:

1. A tool, comprising:
a first capture component having a first configuration to hold a first non-tool component;
a first drive aperture in the first capture component and completely offset from a longitudinal centerline of the tool;
a second capture component having a second configuration to hold a second non-tool component;
wherein the first and second capture components are further configured to receive a third non-tool component attached to one of the first non-tool component and the second non-tool component; and
wherein the first and second capture components are further configured to be rotated by a non-tool drive mechanism that engages the first and second capture components at positions thereon that are completely offset from a longitudinal centerline of the tool.

2. The tool of claim 1, further comprising:
an insertion gap that extends through the first and second capture components to receive the third non-tool component.

3. The tool of claim 1, further comprising:
a midline shelf between the first and second capture components that supports the first non-tool component in the first capture component and supports the second non-tool component in the second capture component.

4. The tool of claim 1, wherein:
the first configuration is different from the second configuration.

5. The tool of claim 1, wherein:
the first non-tool component is different from the second non-tool component.

6. The tool of claim 1, wherein:
the first capture component is a first socket and the second capture component is a second socket.

7. The tool of claim 1, wherein:
the first non-tool component is a first non-tool nut and the second non-tool component is a second non-tool nut.

8. The tool of claim 1, wherein:
the non-tool drive mechanism is a ratchet.

9. A tool, comprising:
a first socket having a first configuration to rotate a first non-tool nut;
a first drive aperture in the first socket and completely offset from a longitudinal centerline of the tool;
a second socket having a second configuration to rotate a second non-tool nut;
wherein the second configuration is different from the first configuration;
a second drive aperture in the second socket and completely offset from the longitudinal centerline of the tool; and
an insertion gap that extends through the first and second sockets and is configured to receive a non-tool component that is affixed to one of the first non-tool nut and the second non-tool nut.

10. The tool of claim 9, further comprising:
a midline shelf between the first and second sockets and that supports the first non-tool nut in the first socket and supports the second non-tool nut in the second socket.

11. The tool of claim 9, wherein the first socket includes:
a first base in an arc shape and has:
a first base interior wall; and
a first base channel in the first base interior wall.

12. The tool of claim 9, wherein the first socket includes:
a first perimeter recess in a reverse tapered shape and has:
a first perimeter recess base interior wall; and
a first perimeter recess base channel in the first perimeter recess base interior wall.

13. The tool of claim 12, further comprising:
a first end post adjacent to the first perimeter recess and the insertion gap.

14. The tool of claim 9, wherein the first socket includes:
a first base plateau that extends perpendicular to the longitudinal centerline.

15. The tool of claim 14, wherein:
the first drive aperture is in the first base plateau.

16. A tool, comprising:
a first socket having a first configuration to receive and rotate a first non-tool nut about a longitudinal centerline of the tool;
wherein the first configuration enables the first socket to receive the first non-tool nut in a first direction parallel to the longitudinal centerline;
a second socket having a second configuration to receive and rotate a second non-tool nut about the longitudinal centerline of the tool;
wherein the second configuration enables the second socket to receive the second non-tool nut in a second direction that is opposite the first direction;
wherein the second configuration is different from the first configuration;
a midline shelf between the first and second sockets that supports the first non-tool nut in the first socket and supports the second non-tool nut in the second socket; and
an insertion gap that is configured to receive a non-tool component that is affixed to one of the first non-tool nut when received by the first socket and the second non-tool nut when received by the second socket;
wherein the tool is a single monolithic structure.

17. The tool of claim 16, further comprising:
a first drive aperture in the first socket, which when activated, causes the first socket to rotate about the longitudinal centerline.

18. The tool of claim 17, further comprising:
a second drive aperture in the second socket, which when activated, causes the second socket to rotate about the longitudinal centerline.

19. The tool of claim 16, wherein the second socket includes:
a second base in an arc shape and has:
a second base interior wall; and
a second base channel in the second base interior wall.

20. The tool of claim 16, wherein the second socket includes:
a second perimeter recess in a reverse tapered shape and has:
a second perimeter recess base interior wall; and
a second perimeter recess base channel in the second perimeter recess base interior wall.
